(19) United States
(12) Patent Application Publication
(10) Pub. No.: US 2025/0376094 A1
(43) Pub. Date: Dec. 11, 2025

(54) RETENTION CLIP FOR A SEAT ASSEMBLY AND METHOD OF ASSEMBLEY

(71) Applicant: LEAR CORPORATION, Southfield, MI (US)

(72) Inventors: Joshua HALLOCK, Warren, MI (US); Lisa SWIKOSKI, West Bloomfield, MI (US); Sam BLAIR, Troy, MI (US); David ABDELLA, Royal Oak, MI (US)

(73) Assignee: LEAR CORPORATION, Southfield, MI (US)

(21) Appl. No.: 18/874,764

(22) PCT Filed: Jun. 15, 2023
(86) PCT No.: PCT/US2023/025363

§ 371 Date: Dec. 13, 2024

Related U.S. Application Data
(60) Provisional application No. 63/366,675, filed on Jun. 20, 2022.

(30) Foreign Application Priority Data
Jan. 19, 2023 (DK) PA202370024

(51) Int. Cl. B60N 2/58

(52) U.S. Cl. CPC B60N 2/5825; B60N 2/5891

(57) ABSTRACT

A retention clip is described that includes an anchor having a body with a first end and a second end opposite the first end, the second end terminating in a tip, the anchor having multiple barbs, each barb extending from the body in a direction away from the tip. The retention clip also includes a retention feature extending away from the first end of the anchor, wherein a material of a mesh structure is gripped between the body and each of the plurality of barbs when the anchor is inserted into the mesh structure. A method of assembling a seat assembly including providing a retention clip is also described.

### CROSS-REFERENCE TO RELATED APPLICATION

This application claims the benefit of U.S. Provisional Patent Application Ser. No. 63/366,675 filed on Jun. 20, 2022, and Danish Patent Application No. PA202370024 filed on Jan. 19, 2023, the disclosures of both of which are hereby incorporated by reference herein in their entireties.

### TECHNICAL FIELD

The present disclosure relates to a retention clip, a seat assembly having a retention clip, and a method of assembly.

### BRIEF DESCRIPTION OF THE DRAWINGS

FIG. 1 is a perspective view of a non-limiting, exemplary embodiment of a seat assembly;

FIG. 2 is a perspective view of a non-limiting, exemplary embodiment of a retention clip according to the present disclosure;

FIGS. 3A and 3B are front and side views of a non-limiting, exemplary embodiment of a retention clip according to the present disclosure;

FIG. 4 is a side view of a non-limiting, exemplary embodiment of a retention clip according to the present invention inserted into a cushion material; and

FIG. 5 is an exemplary flowchart illustrating a non-limiting, exemplary embodiment of a method according to the present disclosure

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising.” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

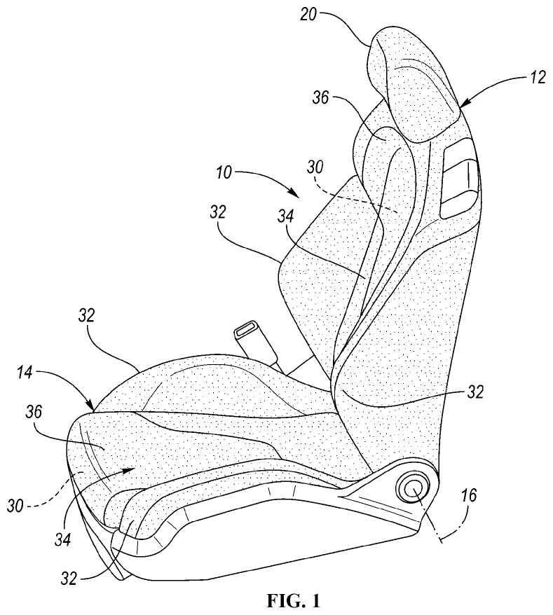

Referring to FIG. 1, an example of a seat assembly 10 is shown. The seat assembly 10 may be configured for use in a vehicle, such as a motor vehicle like a car or truck. The seat assembly 10 may include a seat back 12 and a seat bottom 14. The seat back 12 may be configured to support the back of a seat occupant. The seat bottom 14 may be configured to support a seat occupant. In a vehicular application, the seat bottom 14 may be mounted to a support surface, such as a vehicle floor.

The seat back 12 may be pivotal about an axis 16 with respect to the seat bottom 14. For example, one or more recliner mechanisms, pivot pins, or the like may pivotally connect the seat back 12 to the seat bottom 14. Alternatively, the seat back 12 or a portion thereof may not be pivotally connected to the seat bottom 14. For instance, the seat back 12 may be pivotally mounted to a vehicle body structure, such as may be the case in some bench seat configurations.

The seat back 12 may include a head restraint 20 that may be configured to support the head of a seat occupant. The head restraint 20 may be disposed at the top of the seat back 12. The head restraint 20 may be unitary with the seat back 12 or may be a separate component that is adjustably positionable with respect to the top of the seat back 12.

The seat back 12 and the seat bottom 14 may each have at least one seat cushion 30. The seat back 12 and the seat bottom 14 may each also have side bolsters 32 and a center seating portion 34 of the cushion 30. A seat component 36 may be secured to the cushion 30 with one or more retainers as will be discussed in more detail below.

The seat component 36 may be disposed over or upon the cushion 30. The seat component 36 may have any suitable configuration and be of any suitable type. For instance, the seat component 36 may be a trim cover, trim cover material, or trim cover assembly that provides at least a portion of a visible exterior surface of the seat assembly 10. The trim cover 36 may include a plurality of trim panels that may be assembled in any suitable manner, such as by stitching. The trim panels may be made of any suitable material or materials, such as fabric, leather, vinyl, or combinations thereof. The seat component 36 may also or alternatively be a component that is concealed by or disposed under a trim cover and is disposed on the cushion 30, such as a temperature adjusting device like a heating pad or heating mat, an inflatable device for enhancing comfort of a seat occupant like a lumbar support or that provide massage functionality, an air-permeable material that facilitates airflow for a ventilated seat, or the like.

The cushion 30 may be at least partially concealed by the seat component 36 and may be directly or indirectly supported by a support structure of the seat assembly 10, such as a frame, panel, support wires, or the like. The cushion 30 includes a three-dimensional mesh structure formed of randomly looped and bonded filaments 70, only a small number of examples of which are shown in FIG. 4, pictorially represented by randomly drawn lines for simplicity. For example, the filaments 70 may be extruded filaments that are made of a polymeric material, such as a thermoplastic resin that is polyamide based, polyester based, polyimide based, polyolefin based, polypropylene based, polystyrene based, or combinations thereof. As one example, filaments 70 may be made of linear low-density polyethylene (LLDPE). The extruded filaments 70 may be randomly looped, curled, or entangled and may be bonded together where one filament 70 contacts another, thereby resulting in a lightweight, air permeable cushion having openings or voids between the filaments 70. A method of making an extruded filament mesh cushion is disclosed in U.S. patent application Ser. No. 17/555,875, filed on Dec. 20, 2021, entitled “System and Method of Making a Mesh Cushion,” a copy of which is attached hereto as Appendix A. As such, the cushion 30 may not be made of foam, such as urethane foam, and may partially or completely replace a conventional urethane foam cushion. Alternatively, the cushion may be a conventional foam cushion, such as a urethane foam cushion.

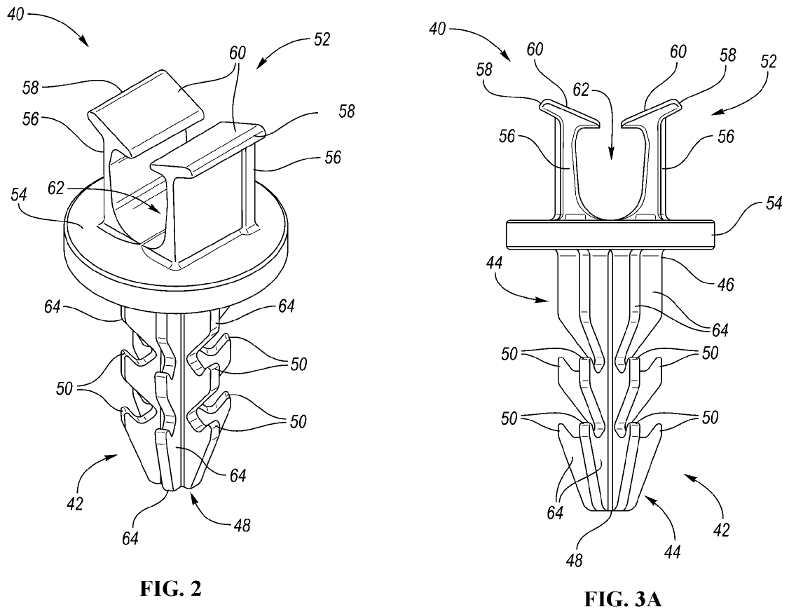

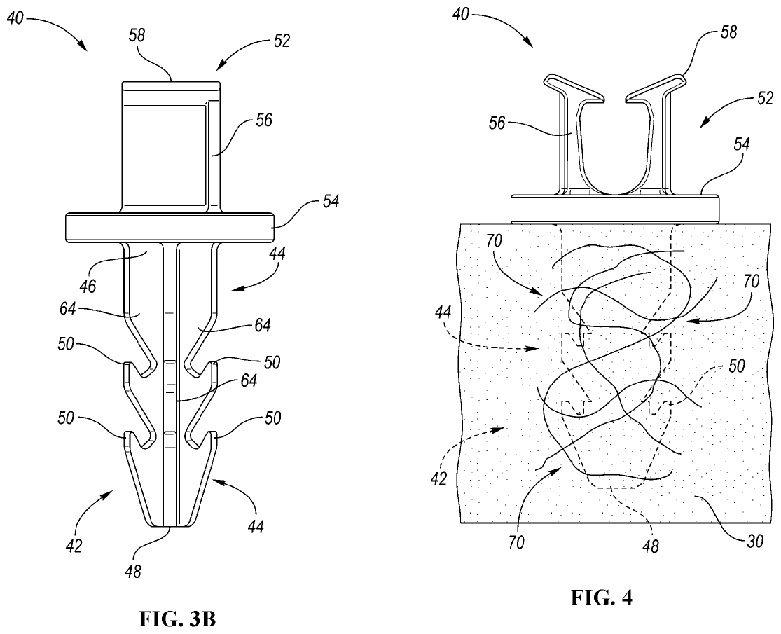

FIG. 2 is a perspective view of a non-limiting exemplary embodiment of a retention clip 40 according to the present disclosure. FIGS. 3A and 3B are front and side views, respectively, of a non-limiting exemplary embodiment of a retention clip 40 according to the present disclosure.

As seen therein, and with continuing reference to FIG. 1, the retention clip 40 includes an anchor 42 having a body 44 with a first end 46 and a second end 48 opposite the first end, the second end 48 terminating in a tip. The anchor 42 has a plurality of barbs 50, each barb 50 extending from the body 44 in a direction away from the tip. The retention clip 40 also includes a retention feature 52 extending away from the first end 46 of the anchor 42. A material of a cushion 30 is gripped between the body 44 and each of the plurality of barbs 52 when the anchor 44 is inserted into the cushion 30 (see FIG. 4), thereby attaching the retention clip 40 to the cushion 30. In that regard, the retention clip 40 may be inserted or installed from an “A” side of the cushion 30. Moreover, the tip at the second end 48 of each anchor 42 may serve or function to pierce the material of the cushion 30, which may include the surface of the cushion 30.

The retention clip 40 further includes a base 54. The anchor 42 and the retention feature 52 are disposed on opposite sides of the base 54, which has a width greater than a width of the body 44. The anchor 42, the retention feature 52, and the base 54 are formed as an integral piece, but may alternatively be individual components attached to each other. In that in regard, the retention clip 40, including the anchor 42, retention feature 52, and the base 54, may be formed by injection molding.

As seen in FIGS. 2 and 3A, the retention feature 52 comprises a pair of spaced apart arms 56 extending from the base 54, each arm 56 terminating in a retention member 58. The arms 56 and retention members 58 are configured to cooperate with a mating attachment feature (not shown) of a trim cover 36, such as beaded Duon® attached to a trim cover 36. More specifically, the retention members 58 have angled guide surfaces 60 that serve or function to guide a mating attachment feature of a trim cover 36 into a space 62 between the arms 56. In the regard, the arms 56 are elastically deformed to receive the matting attachment feature of a trim cover 36. After such insertion of the mating attachment feature of a trim cover 36 into the space 62, the arms 56 return to the positions shown in FIGS. 2 and 3A and the retention members 58 serve or function to hold the mating feature of the trim cover 36 in the space 62, thereby attaching the trim cover 36 to the retention clip 40. In that regard, the retention feature 52 of the retention clip 40 may be attached to a trim cover 36 after the anchor 42 of the retention clip 40 is inserted into a cushion 30.

As also seen in FIGS. 2, 3A, and 3B, the body 44 of the anchor 42 includes a plurality of arms 64, each of which includes a plurality of barbs 50. As shown, body 44 of the anchor 42 has six arms 64, although any number of arms 64 may alternatively be provided. It is noted that the anchor 40, retention feature 52, and/or base 54 are exemplary only, and may generally take or be provided with any shape and/or size. For example, the retention feature 52 may be of any known, appropriate, or suitable type, and the barbs 50 and may generally take or be provided with any shape and/or size. It is also noted that the second end 48 of the anchor 42 may be provided with a pointed tip. In that regard, an anchor 42 having a second end 48 terminated in a pointed tip with a sharp or acute angle and having a smaller cross-sectional area (for a cross-section taken across the body 44 of the anchor 42 in a direction parallel to the base 54) requires the application of less force to insert the anchor 42 into a material of a cushion 30 than does an anchor 42 having a second end 48 terminating in a flat tip or a pointed tip with a greater angle and having a larger cross-sectional area.

It is still further noted that the number of barbs 50 for the anchor 42 illustrated in FIGS. 2, 3A, and 3B is also exemplary only, and any number of barbs 50 may be provided. Moreover, the number of barbs 50 on each side of an anchor 42 may be different, the barbs 50 on each arm 64 need not be located directly across from each other (i.e., mirrored), the barbs 50 along an arm 64 need not be equally spaced from each, and each barb 52 may take or be provided with a different shape. In that regard, the larger the size and/or the greater the number of the barbs 50 of an anchor 42, the more effective the anchor 42 is in grabbing a material of a cushion 30 and the more resistive the anchor 42 will be to removal from or backing out of the cushion 30.

It should be noted, however, that the optimal size and shape of the anchor 40, including barbs 50, may be dependent upon the nature of the material of the cushion 30. In that regard, for a cushion 30 including a three-dimensional mesh structure formed of randomly looped and bonded filaments 60 of an extruded polymeric material or materials as previously described, the manufacturing process may result in a cushion 30 having a material with a larger or smaller cell structure. As a result, the size and shape of the anchor 40 shown in FIGS. 2, 3A, and 3B, or an anchor 40 having a different size or shape than those shown, may be best suited to the material of a particular cushion 30.

FIG. 4 is another side view of a non-limiting, exemplary embodiment of a retention clip 40 according to the present disclosure. As seen therein, the retention clip 40 is partially disposed in a material of a cushion 30. More specifically, the anchor 42 of the retention clip 40 is shown in phantom inserted into the material of the cushion 30, with the base 54 of the retention clip 40 located at a surface of the cushion 30. As previously described, insertion of the anchor 42 of the retention clip 40 into the material of the cushion 30 attaches the retention clip 40 to the cushion 30. Thereafter, the retention feature 52 may be attached to a cooperating attachment feature of a trim cover 36 to attach the retention clip 40 to the trim cover 36. In such a fashion, the trim cover 36 is thereby attached to the cushion 30.

The retention clip 40 of the present disclosure may thus replace known mechanisms, devices, systems, means, or methods for attaching a trim cover 36 to a cushion 30, such as a conventional polyurethane foam cushion, including a clip attached to a trim cover 36 and configured to cooperate with a beaded Duon® attachment feature of a cushion 30, a hog ring and wire fastener, and/or any known attachment system including an attachment feature or fastener molded or formed into the cushion 30, such as foam embedded clips. In that regard, it is noted that the retention clip 40 of the present disclosure need not be formed or molded into the material of a cushion 30. It is also noted that the retention clip 40 of the present disclosure facilitates and/or enables attachment of a trim cover 36 to a cushion 30 that lacks a recess or recesses provided, formed, or created in the cushion for receiving the anchor 42, such as a cushion 30 having a three-dimensional mesh structure formed of randomly looped and bonded filaments 70 of an extruded polymeric material or materials as previously described. Nevertheless, the retention clip 40 of the present disclosure is also suitable for attachment of a trim cover 36 to a cushion 30 that includes a recess or recesses, such as an elongated channel, hole, indentation, or trench provided, formed, or created therein for receiving the anchor 42, which recess or recesses may be provided in any suitable location, for example where a side bolster 32 meets a center seating portion 34 of the cushion 30 (see FIG. 1).

In that regard, as seen in FIG. 4, the cushion 30 includes a three-dimensional mesh structure formed of randomly looped and bonded filaments 70, only a small number of examples of which are shown, pictorially represented by randomly drawn lines for simplicity. As previously described, the second end 48 of the anchor 42 terminates in a tip, and the plurality of barbs 52 extend from the body 46 in a direction away from the tip of the anchor 44, which may serve or function to pierce the material of the cushion 30. As also previously described, when the anchor 42 is inserted into the cushion 30, the material of the cushion 30 (i.e., the looped and bonded filaments 70) is gripped between the body 44 and each of the plurality of barbs 50. The retention clip 40 of the present disclosure thus provides a trim clip with a push-pin style base, where the retention clip 40 grabs a material of a cushion 30, such as strands or filaments of foamless mesh cushions or pads. The retention clip 40 of the present disclosure also provides barbs or barbed attachments and a trim clip to enable or facilitate adhesion of a trim cover 36 to a cushion 30, such as strands or filaments of foamless mesh cushions or pads.

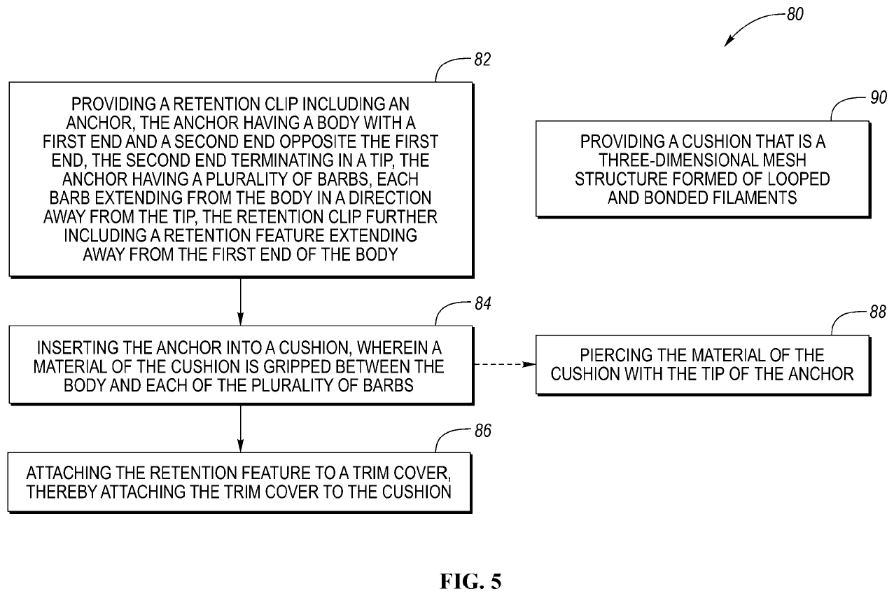

Referring next to FIG. 5, an exemplary flowchart is shown illustrating a non-limiting, exemplary embodiment of a method 80 according to the present disclosure. As seen therein, and with continuing reference to FIGS. 1-4, a method 80 of assembling a seat assembly comprises providing 82 a retention clip 40 including an anchor 42, the anchor 42 having a body 44 with a first end 46 and a second end 48 opposite the first end 46, the second end 48 terminating in a tip, the anchor 42 having a plurality of barbs 50, each barb 50 extending from the body 44 in a direction away from the tip, the retention clip 40 further including a retention feature 52 extending away from the first end 46 of the body 44. The method 80 further comprises inserting 84 the anchor 42 into a cushion 30, wherein a material of the cushion 30 is gripped between the body 44 and each of the plurality of barbs 50, and attaching the retention feature 52 to a trim cover 36, thereby attaching the trim cover 36 to the cushion 30.

According to the method 70 of assembly of the present disclosure, inserting 84 the anchor 42 into the cushion may comprise piercing 88 the material of the cushion 30 with the tip of the anchor 42. As previously described, the retention clip 40 may further comprises a base 54, and the anchor 42 and the retention feature 52 may be disposed on opposite sides of the base 54. As also previously described, the anchor 42, the retention feature 52, and/or the base 54 may be or may be formed as an integral piece. Moreover, the retention feature 52 may be attached to the trim cover 36 after the anchor 42 is inserted into the cushion 30, as also previously described.

The method 80 of assembly of the present disclosure my further comprise providing 90 a cushion 30 that is a three-dimensional mesh structure formed of looped and bonded filaments, as previously described. As also previously described, such filaments may be extruded and formed into the three-dimensional mesh structure. Moreover, as previously described, the assembly method 80 of the present disclosure also facilitates and/or enables attachment of a trim cover 36 to a cushion 30 that lacks a recess or recesses provided, formed or created in the cushion for receiving the anchor 42, such as a cushion 30 having a three-dimensional mesh structure formed of randomly looped and bonded filaments 70 of an extruded polymeric material or materials as previously described. Nevertheless, the retention clip 40 of the present disclosure is also suitable for attachment of a trim cover 36 to a cushion 30 that includes a recess or recesses provided, formed, or created therein.

Item 1: According to an embodiment, the present disclosure provides a retention clip comprising an anchor having a body with a first end and a second end opposite the first end, the second end terminating in a tip, the anchor having a plurality of barbs, each barb extending from the body in a direction away from the tip, and a retention feature extending away from the first end of the anchor, wherein a material of a cushion is gripped between the body and each of the plurality of barbs when the anchor is inserted into the cushion.

Item 2: In another embodiment, the present disclosure provides the retention clip according to Item 1 further comprising a base, wherein the anchor and the retention feature are disposed on opposite sides of the base.

Item 3: In another embodiment, the present disclosure provides the retention clip according to Item 2 wherein the base has a width greater than a width of the body.

Item 4: In another embodiment, the present disclosure provides the retention clip according to any of Items 1-3 wherein the anchor and the retention feature are an integral piece.

Item 5: In another embodiment, the present disclosure provides the retention clip according to any of Items 2-4 wherein the anchor, the retention feature, and the base are an integral piece.

Item 6: In another embodiment, the present disclosure provides the retention clip according to any of Items 1-5 wherein the retention feature is attached to a trim cover after the anchor is inserted into the cushion.

Item 7: In another embodiment, the present disclosure provides the retention clip according to any of Items 1-6 wherein the tip pierces the cushion material.

Item 8: In another embodiment, the present disclosure provides the retention clip according to any of Items 1-7 wherein the material of the cushion comprises a mesh formed of looped and bonded filaments.

Item 9: In another embodiment, the present disclosure provides the retention clip according to Item 8 wherein the filaments are extruded and formed into a three-dimensional structure.

Item 10: In another embodiment, the present disclosure provides the retention clip according to any of Items 1-9 wherein the material of the cushion lacks a formed recess for receiving the anchor.

Item 11: In another embodiment, the present disclosure provides a seat assembly comprising a cushion, a trim cover, and a retention clip according to any of Items 1-10, wherein the retention clip attaches the trim cover to the cushion.

Item 12: According to an embodiment, the present disclosure provides a method of assembling a seat assembly, the method comprising providing a retention clip including an anchor, the anchor having a body with a first end and a second end opposite the first end, the second end terminating in a tip, the anchor having a plurality of barbs, each barb extending from the body in a direction away from the tip, the retention clip further including a retention feature extending away from the first end of the body, inserting the anchor into a cushion, wherein a material of the cushion is gripped between the body and each of the plurality of barbs, and attaching the retention feature to a trim cover, thereby attaching the trim cover to the cushion.

Item 13: In another embodiment, the present disclosure provides the method according to Item 12 wherein inserting the anchor into the cushion comprises piercing the material of the cushion with the tip of the anchor.

Item 14: In another embodiment, the present disclosure provides the method according to any of Items 12-13 wherein the retention clip further comprises a base, and wherein the anchor and the retention feature are disposed on opposite sides of the base.

Item 15: In another embodiment, the present disclosure provides the method according to any of Items 12-14 wherein the anchor and the retention feature are an integral piece.

Item 16: In another embodiment, the present disclosure provides the method according to any of Items 13-15 wherein the anchor, the retention feature, and the base are an integral piece.

Item 17: In another embodiment, the present disclosure provides the method of any of Items 12-16 wherein the retention feature is attached to the trim cover after the anchor is inserted into the cushion.

Item 18: In another embodiment, the present disclosure provides the method according to any of Items 12-17 further comprising providing a cushion that is a three-dimensional mesh structure formed of looped and bonded filaments.

Item 19: In another embodiment, the present disclosure provides the method according to Item 18 wherein the filaments are extruded and formed into the three-dimensional mesh structure.

Item 20: In another embodiment, the present disclosure provides the method according to any of Items 12-19 wherein the material of the cushion lacks a formed recess for receiving the anchor.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

1. A retention clip comprising:
an anchor having a body with a first end and a second end opposite the first end, the second end terminating in a tip, the anchor having a plurality of barbs, each barb extending from the body in a direction away from the tip; and
a retention feature extending away from the first end of the anchor, wherein a material of a mesh structure is gripped between the body and each of the plurality of barbs when the anchor is inserted into the mesh structure.

2. The retention clip according to claim 1 further comprising a base, wherein the anchor and the retention feature are disposed on opposite sides of the base.

3. The retention clip according to claim 2 wherein the base has a width greater than a width of the body.

4. The retention clip according to claim 1 wherein the anchor and the retention feature are an integral piece.

5. The retention clip according to claim 2 wherein the anchor, the retention feature, and the base are an integral piece.

6. The retention clip according to claim 1 wherein the retention feature is attached to a cover after the anchor is inserted into the mesh structure.

7. The retention clip according to claim 1 wherein the tip pierces the mesh structure.

8. The retention clip according to claim 1 wherein the mesh structure comprises a mesh formed of looped and bonded filaments.

9. The retention clip according to claim 8 wherein the filaments are extruded and formed into a three-dimensional structure.

10. The retention clip according to claim 1 wherein the material of the mesh structure lacks a formed recess for receiving the anchor.

11. An assembly comprising:
a mesh structure;
a cover; and
a retention clip according to claim 1, wherein the retention clip attaches the cover to the mesh structure.

12. A method comprising:
providing a retention clip including an anchor, the anchor having a body with a first end and a second end opposite the first end, the second end terminating in a tip, the anchor having a plurality of barbs, each barb extending from the body in a direction away from the tip, the retention clip further including a retention feature extending away from the first end of the body;
inserting the anchor into a mesh structure, wherein the mesh structure is gripped between the body and each of the plurality of barbs; and
attaching the retention feature to a cover, thereby attaching the cover to the cushion.

13. The method according to claim 12 wherein inserting the anchor into the mesh structure comprises piercing the mesh structure with the tip of the anchor.

14. The method according to claim 12 wherein the retention clip further comprises a base, and wherein the anchor and the retention feature are disposed on opposite sides of the base.

15. The method according to claim 12 wherein the anchor and the retention feature are an integral piece.

16. The method according to claim 13 wherein the anchor, the retention feature, and the base are an integral piece.

17. The method of claim 12 wherein the retention feature is attached to the cover after the anchor is inserted into the mesh structure.

18. The method according to claim 12 further comprising providing a mesh structure comprising a three-dimensional mesh structure formed of looped and bonded filaments.

19. The method according to claim 18 wherein the filaments are extruded and formed into the three-dimensional mesh structure.

20. The method according to claim 12 wherein the mesh structure lacks a formed recess for receiving the anchor.
